(19) United States
(12) Patent Application Publication
(10) Pub. No.: US 2018/0340531 A1
(43) Pub. Date: Nov. 29, 2018

(54) VARIABLE DISPLACEMENT FUEL PUMP BACKGROUND

(71) Applicant: HAMILTON SUNDSTRAND CORPORATION, Charlotte, NC (US)

(72) Inventors: Weishun Willaim Ni, Rockton, IL (US); Dennis L. Kaderabek, Caledonia, IL (US); Edward W. Goy, Crystal Lake, IL (US); Dennis A. Erickson, Rockton, IL (US); David Lauriat, DeKalb, IL (US)

(21) Appl. No.: 15/602,364

(22) Filed: May 23, 2017

(51) Int. Cl. F04B 49/12; F04B 15/00; F04B 19/02; F04B 23/02; F04B 53/16; F04B 53/14; F04B 9/02; F04B 53/10; F02M 37/04; F02M 37/06; B64D 37/00

(52) U.S. Cl. CPC F04B 49/128; F04B 15/00; F04B 19/025; F04B 23/02; F04B 53/162; F02C 7/22; F04B 9/02; F04B 53/10; F02M 37/043; F02M 37/06; B64D 37/005; F04B 53/14

(57) ABSTRACT

A variable displacement fuel pump includes a pump body, a barrel disposed within the pump body, at least one piston disposed in the barrel, wherein the at least one piston is configured to reciprocate within the barrel, and an electronic control actuator operatively coupled to the barrel, wherein the control actuator rotates the barrel to a selected barrel angle relative to the at least one piston in response to a desired fuel flow.

The subject matter disclosed herein relates to fuel pumps, and more particularly, to variable displacement fuel pumps with electronic actuators.

High pressure fuel systems are typically used in a variety of applications to provide fuel flow and pressure sufficient to engines during various levels of demand. Fuel systems often designed to provide excess fuel flow to ensure fuel demands are met during all operation conditions. Often, excess fuel flow can waste energy and cause extra fuel heating. Another critical condition to which the fuel system must respond occurs during a quick acceleration. When the engine is accelerated, energy must be furnished to the turbine in excess of that necessary to maintain a constant RPM. However, if the fuel flow increases too rapidly, an over-rich mixture may be produced causing a surge.

In more detail, such systems typically operate such that unused fuel is recirculated continuously. The recirculation can be achieved by a bypass valve and a high pressure fixed displacement fuel pump but the valve and pump lead to the fuel heating described above. Further, the fixed displacement pump is typically oversized to provide the excess fuel capacity and this leads to the recirculation of large amounts of pressurized fuel. As the fuel is returned and recirculated, the pressure drops and heat is generated.

### BRIEF SUMMARY

According to an embodiment, a variable displacement fuel pump includes a pump body, a barrel disposed within the pump body, at least one piston disposed in the barrel, wherein the at least one piston is configured to reciprocate within the barrel, and an electronic control actuator operatively coupled to the barrel, wherein the control actuator rotates the barrel to a selected barrel angle relative to the at least one piston in response to a desired fuel flow.

According to an embodiment, a fuel system includes a fuel source, a variable displacement fuel pump, including a pump body, a barrel disposed within the pump body, at least one piston disposed in the barrel, wherein the at least one piston is configured to reciprocate within the barrel to provide a fuel flow, and an electronic control actuator operatively coupled to the barrel, wherein the control actuator rotates the barrel to a selected barrel angle relative to the at least one piston in response to a desired fuel flow parameter, a controller to receive a thrust demand parameter to provide the desired fuel flow parameter to the electronic control actuator, and a thrust output device to receive the fuel flow to provide a thrust output corresponding to the thrust demand parameter.

According to an embodiment, a method to provide a desired thrust output corresponding to a thrust demand parameter includes receiving the thrust demand parameter via a controller, providing a desired fuel flow parameter via the controller, providing a fuel flow via a variable displacement fuel pump, including a pump body, a barrel disposed within the pump body, and at least one piston disposed in the barrel, wherein the at least one piston is configured to reciprocate within the barrel to provide the fuel flow, and rotating the barrel of the variable displacement fuel pump to a selected barrel angle relative to the at least one piston in response to the desired fuel flow parameter via an electronic control actuator.

Technical function of the embodiments described above includes an electronic control actuator operatively coupled to the barrel, wherein the control actuator rotates the barrel to a selected barrel angle relative to the at least one piston in response to a desired fuel flow.

Other aspects, features, and techniques of the embodiments will become more apparent from the following description taken in conjunction with the drawings.

### BRIEF DESCRIPTION OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the FIGURES:

FIG. 1 is a schematic view of an embodiment of a fuel system; and

FIG. 2 is a partial cross sectional view of an embodiment of a variable displacement pump for use with the fuel system of FIG. 1.

### DETAILED DESCRIPTION

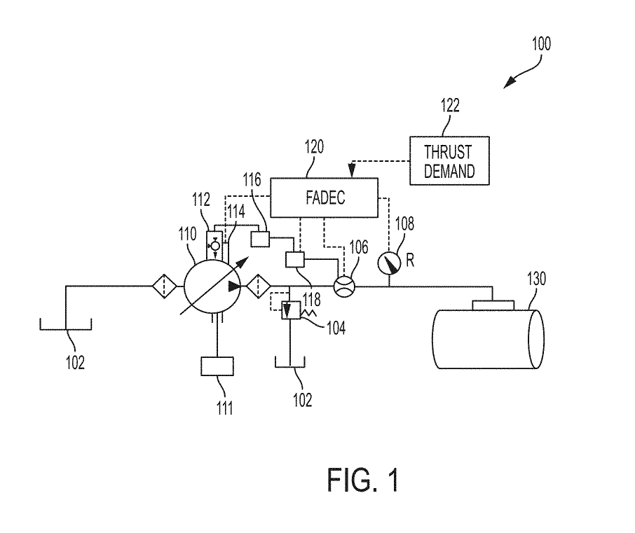

Referring to the drawings, FIG. 1 shows a fuel system 100 according to one embodiment. In the illustrated embodiment, the fuel system 100 includes a fuel source 102, a variable displacement pump 110, a high pressure relief valve 104, a mass fuel metering sensor 106, a fuel flow pressure sensor 108, a full authority digital engine control (FADEC) 120, and a thrust output device 130. In the illustrated embodiment, the fuel system 100 provides a fuel flow from the fuel source 102 to the thrust output device 130 at a desired fuel flow rate to provide a desired thrust indicated by an operator.

The fuel source 102 can include fuel tanks or other portions of the fuel system 100 not shown. In the illustrated embodiment, the fuel source 102 can provide fuel to the variable displacement pump 110. In certain embodiments, excess or relief fuel flow from the variable displacement pump 110 can be redirected to the fuel source 102 via the high pressure relief valve 104.

In the illustrated embodiment, the thrust output device 130 is any suitable thrust output device, including, but not limited to, a gas turbine engine. Gas turbine engine thrust output is primarily controlled by the amount of fuel supplied to the engine combustion chamber via the engine nozzles. Therefore, the thrust output of the gas turbine engine or any suitable thrust output device 130 is based on the amount of fuel supplied to the thrust output device 130. During flight operations, thrust demands can change rapidly, requiring rapid changes in fuel flow. In certain embodiments, thrust demands can be independent from engine operation speed.

In the illustrated embodiment, a variable displacement pump 110 can provide a desired fuel flow to the thrust output device 130 without excess fuel being returned to the fuel source 102. In the illustrated embodiment, the variable displacement pump 110 is driven by a pump drive 111. The pump drive 111 can be provided by an engine or any other suitable source, including the thrust output device 130. In the illustrated embodiment, the variable displacement pump 110 includes an electronic control actuator 112 to control the displacement of the variable displacement pump 110 to provide a desired fuel flow rate independent of the pump drive 111 speed in response to the thrust demand 122 received by the FADEC 120.

In the illustrated embodiment, the mass fuel metering sensor 106 can measure mass fuel flow from the variable displacement pump 110 to the thrust output device 130. In the illustrated embodiment, the mass fuel metering sensor 106 can provide fine control and transient control of fuel flow to the thrust output device 130. In the illustrated embodiment, as the mass fuel metering sensor 106 measures fuel flow there through, any excess flow can be relieved by the high pressure relief valve 104 to be released back into the fuel source 102. The high pressure relief valve 104 can prevent fuel pressure from exceeding a desired pressure. The operation of the mass fuel metering sensor 106 can be controlled by the FADEC 120 in response to the thrust demand 122 and the fuel flow pressure sensor 108.

In the illustrated embodiment, the FADEC 120 can receive parameters regarding flight operation and control various aspects of the fuel system 100, including the variable displacement pump 110. In the illustrated embodiment, the FADEC 120 can receive a thrust demand parameter 122 from an operator. In certain embodiments, the thrust demand parameter 122 can be calculated by other flight systems. Further, in the illustrated embodiment, the FADEC 120 can receive information regarding the fuel flow and fuel pressure received by the thrust output device 130 via a fuel flow pressure sensor 108. In the illustrated embodiment, the fuel flow pressure 108 measures one or more of fuel flow and pressure and provides these parameters to the FADEC 120.

In response to the measured parameters from the fuel flow pressure sensor 108 and the thrust demand parameter 122, the FADEC 120 can adjust the control actuator 112 of the variable displacement pump 110 to provide a desired fuel flow to the thrust output device 130. In certain applications, the FADEC 120 can provide the desired fuel flow to the thrust output device 130 by precisely controlling the output of the variable displacement pump 110. In the illustrated embodiment, the FADEC 120 can minimize flow to prevent excess return or bypass of fuel flow to the fuel source 102 via the high pressure relief valve 104. In certain embodiments, the mass fuel metering sensor 106 may be utilized for fine and transient adjustments of fuel flow to the thrust output device 130.

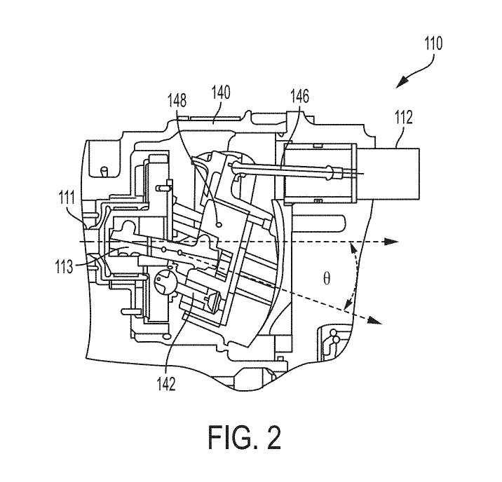

Referring to FIG. 2, an example variable displacement pump 110 is shown. In the illustrated embodiment, the variable displacement pump 110 includes the electronic control actuator 112, an actuator rod 146, a pump body 140, pistons 142, and a barrel 148. In the illustrated embodiment, a variable displacement pump 110 can vary the displacement or the amount of fluid pumped per revolution of the pump drive 111 while the variable displacement pump 110 is running. In the illustrated embodiment, the variable displacement pump 110 is an axial piston pump. In the illustrated embodiment, the control actuator 112 can tilt or rotate the barrel 148 relative to the pistons 142 to control the output of the variable displacement pump 110 independent of the input provided by the pump drive 111. Advantageously, the use of a variable displacement pump 110 allows for high efficiency at various flow requirements.

In the illustrated embodiment, the pistons 142 reciprocate within the barrel 148. The pistons 142 are powered by the pump drive 111. In the illustrated embodiment, the pistons 142 are disposed in cylinders arranged parallel to each other and rotating around a central shaft 113 powered by the pump drive 111. In the illustrated embodiment, the variable displacement pump 110 can include any suitable number of pistons 142. In the illustrated embodiment, the variable displacement pump 110 includes 9 pistons.

In the illustrated embodiment, the barrel 148 can tilt or rotate relative to the pistons 142. The angle of the barrel 148 can change the stroke of the pistons 142. The angle between the barrel 148 and the center drive shaft 111 can be described as angle theta. In the illustrated embodiment, the variable displacement pump 110 is a bent swash plate axis pump, wherein the barrel 148 provides a maximum displacement capacity when the angle theta is maximized, while the variable displacement pump 110 provides 0 or minimum pumping capacity when the angle theta is zero or inline.

In the illustrated embodiment, the electronic control actuator 112 is coupled to the barrel 148 via an actuator rod 146. The electronic control actuator 112 can adjust the angle theta of the barrel 148 to vary the displacement of the variable displacement pump 110. In the illustrated embodiment, the position of the electronic control actuator 112 can be related to the angle theta of the barrel 148 and further be related to a fuel flow rate of the variable displacement pump 110 for a given pump drive 111 speed. Therefore, in certain embodiments, the FADEC 120 can relate and command the position of the electronic control actuator 112 to provide a desired fuel flow rate.

Further, in certain embodiments the electronic control actuator 112 has a servomechanism for position feedback to the FADEC 120 to allow for closed loop control of the variable displacement pump 110. In certain embodiments, the electronic control actuator 112 can be a rotary actuator, a linear actuator, or any other suitable actuator. Advantageously, the electronic control actuator 112 can vary the output of the variable displacement pump 110 independent of the speed of the pump drive 111. Further, the use of an electronic control actuator 112 can allow for a rapid flow response (within 30 milliseconds) within the fuel system 100 to allow for rapid actuated flow slew rates.

Advantageously, by utilizing the variable displacement pump 110 with the electronic control actuator 112, a desired fuel flow can be provided with minimal excess fuel flow being directed back to the fuel source 102. By maintaining a desired fuel flow rate, excess heating of fuel is minimized, minimizing fuel contamination and allowing for greater reliability. Further, the use of the electronic actuator 112 allows for simplified components within the fuel system 100 to simplify assembly and minimize weight. Further, improved transient response due to the electronic actuator 112 can prevent lean die-out or rich blow out conditions by allowing improved fuel flow control in transient applications.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. A variable displacement fuel pump, comprising:
a pump body;
a barrel disposed within the pump body;
at least one piston disposed in the barrel, wherein the at least one piston is configured to reciprocate within the barrel; and
an electronic control actuator operatively coupled to the barrel, wherein the electronic control actuator rotates the barrel to a selected barrel angle relative to the at least one piston in response to a desired fuel flow.

2. The variable displacement fuel pump of claim 1, wherein the electronic control actuator is an electronic rotary actuator.

3. The variable displacement fuel pump of claim 1, wherein the electronic control actuator is an electronic linear actuator.

4. The variable displacement fuel pump of claim 1, wherein the electronic control actuator includes a servo mechanism.

5. A fuel system, comprising:
a fuel source;
a variable displacement fuel pump, including:
a pump body;
a barrel disposed within the pump body;
at least one piston disposed in the barrel, wherein the at least one piston is configured to reciprocate within the barrel to provide a fuel flow; and
an electronic control actuator operatively coupled to the barrel, wherein the electronic control actuator rotates the barrel to a selected barrel angle relative to the at least one piston in response to a desired fuel flow parameter;
a controller to receive a thrust demand parameter to provide the desired fuel flow parameter to the electronic control actuator; and
a thrust output device to receive the fuel flow to provide a thrust output corresponding to the thrust demand parameter.

6. The fuel system of claim 5, wherein the electronic control actuator is an electronic rotary actuator.

7. The fuel system of claim 5, wherein the electronic control actuator is an electronic linear actuator.

8. The fuel system of claim 5, wherein the electronic control actuator includes a servomechanism.

9. The fuel system of claim 5, further comprising a high pressure relief valve to selectively direct the fuel flow to the fuel source.

10. The fuel system of claim 5, further comprising a mass fuel metering sensor to control the fuel flow to the thrust output device.

11. The fuel system of claim 5, further comprising a fuel flow pressure sensor to provide a measured fuel flow parameter to the controller.

12. A method to provide a desired thrust output corresponding to a thrust demand parameter, the method comprising:
receiving the thrust demand parameter via a controller;
providing a desired fuel flow parameter via the controller;
providing a fuel flow via a variable displacement fuel pump, including:
a pump body;
a barrel disposed within the pump body; and
at least one piston disposed in the barrel, wherein the at least one piston is configured to reciprocate within the barrel to provide the fuel flow; and
rotating the barrel of the variable displacement fuel pump to a selected barrel angle relative to the at least one piston in response to the desired fuel flow parameter via an electronic control actuator.

13. The method of claim 12, wherein the electronic control actuator is an electronic rotary actuator.

14. The method of claim 12, wherein the electronic control actuator is an electronic linear actuator.

15. The method of claim 12, wherein the electronic control actuator includes a servo mechanism.

16. The method of claim 12, further comprising selectively directing the fuel flow to a fuel source via a high pressure relief valve.

17. The method of claim 12, further comprising controlling the fuel flow to the thrust output device via a mass fuel metering sensor.

18. The method of claim 12, further comprising providing a measured fuel flow parameter to the controller via a fuel flow pressure sensor.
